(19) United States
(12) Patent Application Publication
(10) Pub. No.: US 2026/0083072 A1
(43) Pub. Date: Mar. 26, 2026

(54) FLOATING SUBSTRATES FOR OFFSHORE CULTIVATION OF TARGET PRODUCTS AND METHODS OF MAKING AND USING THE SAME

(71) Applicant: Knudsen Holdings LLC, Cape Elizabeth, ME (US)

(72) Inventors: Justin Baker RIES, Swampscott, MA (US); Matthew Jordan ODLIN, Freeport, ME (US)

(21) Appl. No.: 19/197,235

(22) Filed: May 2, 2025

Related U.S. Application Data
(63) Continuation of application No. 18/894,413, filed on Sep. 24, 2024, now abandoned.
Application No. 18/894,413 is a continuation of application No. PCT/US2023/064917, filed on Mar. 24, 2023.
(60) Provisional application No. 63/323,285, filed on Mar. 24, 2022.

(51) Int. Cl. A01G 33/00

(52) U.S. Cl. CPC A01G 33/00

(57) ABSTRACT

A method of using a floating substrate for cultivating a target product includes providing a naturally occurring material, and forming the naturally occurring material into a substrate. The substrate is deployed into a body of water. The substrate can be pre-seeded with a target product and/or can be configured attract the target product present in the body of water after being deployed. The substrate is allowed to transition from a first configuration to a second configuration when an amount of biomass accumulation of the target product is at least a threshold amount of biomass accumulation. In some instances, a buoyancy of the substrate in the first configuration may be greater than a threshold buoyancy and a buoyancy of the substrate in the second configuration may be less than the threshold buoyancy, thereby allowing the substrate and the target product to sink to a bottom of the body of water.

### CROSS-REFERENCE TO RELATED APPLICATIONS

This application is a continuation of U.S. patent application Ser. No. 18/894,413, filed Sep. 24, 2024, entitled “Floating Substrates for Offshore Cultivation of Target Products and Methods of Making and Using the Same,” which is a continuation of International Patent Application No. PCT/US2023/064917, filed Mar. 24, 2023, entitled “Floating Substrates for Offshore Cultivation of Target Products and Methods of Making and Using the Same,” which claims priority to and the benefit of U.S. Provisional Patent Application Ser. No. 63/323,285, filed Mar. 24, 2022, entitled “Floating Substrates for Offshore Cultivation of Target Products and Methods of Making and Using the Same,” the disclosure of which is incorporated herein by reference in its entirety.

### BACKGROUND

The present disclosure relates generally to the cultivation of marine target products and more particularly, to floating substrates for offshore cultivation of marine target products and methods of making and using the same.

Advances in technology and industrialization have led to increasing amounts of harmful anthropogenic greenhouse gas emissions, which have contributed to global warming. One attempt at addressing the accumulation of atmospheric greenhouse gases is carbon sequestration, or the process of capturing and sequestering atmospheric carbon dioxide. To be atmospherically significant, however, it is generally desirable for carbon sequestration technologies to be capable of capturing carbon at gigaton scale. Marine species such as macroalgae, microalgae, calcifying organisms, plankton, filter feeders, and/or the like (also referred to as marine mass) have shown promise as a carbon sequestration technology as wild growth currently contributes to naturally occurring carbon sequestration to the seafloor. Therefore, increasing and/or improving cultivation and accumulation of marine mass can provide additional benefits.

The cultivation of marine species can have many advantages compared to the cultivation of plants on land. For example, the cultivation of marine mass typically leads to higher productivity and does not require significant use of scarce resources such as farmlands, freshwater, and/or additional nutrients. Known methods for cultivating marine mass, however, can be labor intensive, inefficient, difficult to scale, and/or expensive. Moreover, some known methods include cultivation near shore and/or the use of reusable/recoverable floatation elements, single-use engineered materials, multi-component assemblies, and/or the like. As such, some known methods remain unsuitable, labor intensive, and/or expensive for large scale carbon sequestration applications.

### SUMMARY

Embodiments describes herein relate to systems, devices, and methods that include the use of floating substrates for offshore cultivation of marine target products and, in particular, to floating substrates that are formed from naturally occurring products in which a marine target product is embedded, seeded, and/or coupled to, and that are used for offshore cultivation of the marine target product for carbon sequestration. In some implementations, a method of using such a floating substrate for cultivating a target production includes providing a naturally occurring material, and forming the naturally occurring material into a substrate. The substrate is deployed into a body of water, the substrate being at least one of pre-seeded with a target product before being deployed, or configured to attract target product present in the body of water so as to become seeded with the target product after being deployed. The substrate is allowed to transition from a first configuration to a second configuration when an amount of biomass accumulation of the target product is at least a threshold amount of biomass accumulation.

In some implementations, a buoyancy of the substrate in the first configuration is greater than a threshold buoyancy and a buoyancy of the substrate in the second configuration is less than the threshold buoyancy. In some instances, the threshold buoyancy is a buoyancy below which the substrate sinks to the bottom of a body of water.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flowchart of a method for cultivation of marine target products, according to an embodiment.

FIGS. 2A and 2B are schematic illustrations of a cultivation apparatus in a first configuration and a second configuration, respectively, according to an embodiment.

FIG. 3 is a schematic illustration of a cultivation apparatus configured to have a tubular shape, according to an embodiment.

FIG. 4 is a schematic illustration of a cultivation apparatus configured to have a substantially planar shape, according to an embodiment.

FIG. 5 is a schematic illustration of a cultivation apparatus including a bag containing selectively buoyant material, according to an embodiment.

FIG. 6 is a schematic illustration of a cultivation apparatus including a seeding layer, according to an embodiment.

FIG. 7 is a schematic illustration of a cultivation apparatus including a hollow substrate, according to an embodiment.

FIG. 8 is a schematic illustration of a cultivation apparatus, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Interest in large-scale (e.g., on the order of multi-gigatons) sequestration of the biomass of target products (marine biomass) continues to increase as a pathway for addressing the accumulation of harmful anthropogenic greenhouse gases in the atmosphere. In addition, in an attempt to abate greenhouse gas emissions, governments and/or regulatory authorities have established greenhouse gas emissions caps and, where compliance is impracticable, have allowed organizations to comply with the emissions caps by purchasing carbon credits and/or offsets. For example, carbon sequestered using carbon sequestration technologies can be quantified, calculated, and/or valued and a credit tied to and/or otherwise associated with the calculated amount of carbon sequestered can be sold in a carbon credit market (or any other suitable market). As prices in the global carbon credit market continue to climb, it remains desirable to improve and/or develop new systems, devices, and/or methods for carbon sequestration at a scale that is atmospherically significant for carbon sequestration applications.

Target products such as certain aquatic and/or marine species have shown promise as a carbon sequestration technology as a portion of their biomass naturally sinks to the seafloor, sequestering any amount of carbon captured. Cultivation of such target products has the potential to improve this quantity and/or rate of sequestration significantly due to increased cultivation productivity relative to the naturally occurring species. In some implementations, cultivation can include seeding a substrate or structure with a target product, deploying the seeded substrate in a body of water such as open ocean, and allowing biomass to accumulate until reaching a certain threshold value. After accumulating a desired or threshold amount of biomass, the target product is allowed (or caused) to sink to the ocean floor, thereby effectively sequestering an amount of carbon dioxide captured by the target product.

Many marine target products (e.g., macroalgae) show promise as a carbon sequestration pathway as their wild growth currently contributes to naturally occurring carbon sequestration to the seafloor. Target product cultivation has the potential to improve this sequestration rate significantly due to increased cultivation productivity and sinking/sequestration rate relative to these naturally occurring phenomena. Target products can be cultivated in oceans, estuaries, lakes, rivers, and/or any other suitable body of water. These target products can be allowed to grow and accumulate biomass. Biomass may be corporeally retained or eroded (allowed to naturally break off and sink) into the water. Typically, after the accumulation reaches a certain threshold value, the target products are allowed to sink (or caused to sink) to the seafloor, thereby effectively sequestering the carbon dioxide associated with the accumulated target product.

Accordingly, carbon credits can be associated with the accumulation of the target product and/or capacity of the target product to sequester carbon. For instance, an amount of carbon that can be sequestered per unit of target product (e.g., that is sunk to the bottom of a body of water) can be calculated and/or predicted and sold in a carbon credit market (or any other suitable market) as a credit. In some instances, predicting growth, performance characteristics, and/or the capacity of the target product to sequester carbon can for example, enable the predicted capacity to be bought and/or sold as a commodity (e.g., in a commodities market, in a futures market, and/or in any other suitable market). Accordingly, accurately predicting target product accumulation and/or erosion can be useful to calculate carbon dioxide offset credits.

In some instances, systems and/or methods can use and/or implement a combination of multiple models (e.g., machine learning models, probabilistic models, statistical models, stochastic models, a combination thereof, and/or the like) to determine carbon dioxide offset credits. For example, a quantification model can receive as input, sensor data that is associated with a deployment and/or a portion of a deployment (e.g., one or more cultivation apparatus as discussed below) for cultivating target product. The quantification model can also receive outputs from at least one model from the multiple models. Each of these models can predict, for example, one or more characteristics associated with the target product, one or more characteristics associated with the deployment and/or the portion of the deployment, one or more characteristics associated with an environment in which the deployment and/or the portion of the deployment is deployed, and/or any other suitable characteristic. Executing the quantification model can generate an output that can predict and/or that can be used to predict a capacity of the target product of the deployment to sequester carbon dioxide. In some instances, carbon dioxide offset credits can be calculated based on the predicted capacity of the target product to sequester carbon dioxide. Since the quantification model uses the outputs from multiple models, the quantification model can predict the capacity of the target product with a higher degree of accuracy than a prediction based on each individual model.

In some embodiments, a method can include obtaining sensor data associated with at least a portion of a deployment for cultivating a target product in a body of water, executing at least one model based on the sensor data to generate an output predicting at least one characteristic associated with the target product, the deployment, and/or a portion of the body of water, and inputting the output into a quantification model. The quantification model is executed to generate an output associated with a predicted capacity of the target product to sequester carbon dioxide and a carbon dioxide offset credit is determined based on the predicted capacity resulting from output of the quantification model. An accuracy of the predicted capacity resulting from the output of the quantification model can be greater than an accuracy of a predicted capacity resulting from the output of each model individually.

In some embodiments, a method can include obtaining sensor data associated with a deployment for cultivating a target product in a body of water. The method can also include providing at least a portion of the sensor data as an input to at least one model from a number of models associated with the target product, the deployment, and/or a portion of the body of water in which the deployment is disposed. The models are executed in a predetermined sequence such that an output of a current model is an input for at least one subsequently executed model in the predetermined sequence. An output of a last model executed in the sequence is provided as input to a quantification model, which is executed to generate an output associated with a predicted capacity of the target product to sequester carbon dioxide.

In some embodiments, a method can include obtaining first sensor data from at least one sensor associated with at least one cultivation apparatus for cultivating a target product and second sensor data from at least one sensor associated with a deployment of any number of cultivation apparatus. The deployment being deployed in an ocean. The at least one cultivation apparatus being included in the plurality of cultivation apparatus. A first model is trained, based at least in part on the first sensor data, to generate a first output predicting at least one parameter associated with a growth of the target product of the at least one cultivation apparatus, and a second model is trained, based at least in part on the second sensor data, to generate a second output predicting a geographic dispersion of the deployment in the ocean. The method further includes training a third model, based at least in part on the first output and the second output, to generate a third output predicting an amount of accumulation of the target product of the deployment.

In addition to sequestering carbon captured by the target products, it may be desirable to source, form, and/or produce the substrate on which the target product is seeded or otherwise coupled from naturally occurring materials (or from byproducts resulting from other processes) to limit carbon emissions associated with production. In addition or as an alternative, in some implementations, the naturally occurring material can sequester CO₂ directly in the production of the substrate, the transformation of the substrate, and/or the dissolution of the substrate (for example, via ocean alkalinization), and/or in the transport, deposition, and/or burial of the substrate if/when the substrate is removed from the surface of the body of water, the atmosphere, and/or a short-term carbon cycle in the coupled surface water-atmosphere system. Similarly, it may be desirable to allow the substrates to sink along with the target product, thereby reducing carbon emissions otherwise associated with the process of recovering used substrates. Accordingly, a need exists for improved structures for offshore cultivation of target products and improved methods of make and using the same.

The embodiments and/or methods described herein relate to cultivation apparatus or substrates that can be used for offshore cultivation of marine target products that, for example, can be selectively buoyant, non-buoyant, variably buoyant, and/or formed from naturally occurring materials. Embodiments described herein may provide one or more benefits including, for example: (1) forming floating substrates from naturally occurring materials which can be formed from recyclable materials and/or from byproducts of other processes reducing, and/or sequestering carbon emissions and reducing manufacturing costs; (2) allowing and/or promoting seeding, attachment, and/or incorporation of the target products directly into the substrate, reducing or eliminating the use of separate components for seeding the target products; (3) enabling natural degradation of the substrate in the water without contamination of the water, and potentially sequestering carbon through direct air capture and/or alkalinization of the surface water (e.g., surface ocean), thus reducing environmental pollution, atmospheric CO2, global warming, ocean acidification, and/or negative impact(s) on marine and/or terrestrial life; (4) precluding the use of high cost and complex materials for forming the floating substrates, thereby reducing manufacturing and operational complexity and cost; (5) allowing seeding of the target products to the naturally occurring material, or other components of the cultivation forming the cultivation apparatus, thus providing manufacturing flexibility and ability to use in a wide variety of carbon sequestration applications; and/or the like.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “target product” generally refers to one or more aquatic and/or marine species of interest. For example, a “target product” can include but is not limited to aquatic and/or marine species such as calcifying organisms, plankton, archaea filter feeders (e.g., oysters, clams, etc.), bacteria and other microorganisms, heterokonts like algae(s) (e.g., microalgae, macroalgae, etc.), and/or the like. In other implementations, however, a target product can refer to any suitable species whose cultivation leads to a desired result (e.g., as a harvested product, for bioremediation, for carbon capture and sequestration, and/or the like).

The target products described herein can be select marine species who's natural and/or desired habitat is a body of water. When referring to a body of water, it should be understood that the body of water can be selected based on characteristics that may facilitate the cultivation of the target product. Accordingly, though specific bodies of water may be referred to herein (e.g., an ocean or sea), it should be understood that the embodiment, example, and/or implementation so described is not limited to use in such an environment unless the context clearly states otherwise. Moreover, the term “saltwater” as used in this specification is intended to refer to any body of water the constituents of which include a certain concentration of salt(s). In contrast “freshwater” can refer to any body of water the constituents of which do not include or include limited concentrations of salt(s). Saltwater, for example, can refer to the water forming oceans, seas, bays, gulfs, as well as surface and/or subsurface brines, etc. Freshwater, for example, can refer to the water forming rivers, lakes, etc. Moreover, bodies of water described herein can also include certain mixtures of freshwater and saltwater (generally known as “brackish”) such as, for example, the mixture of river water and sea water found in estuaries and/or the like.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

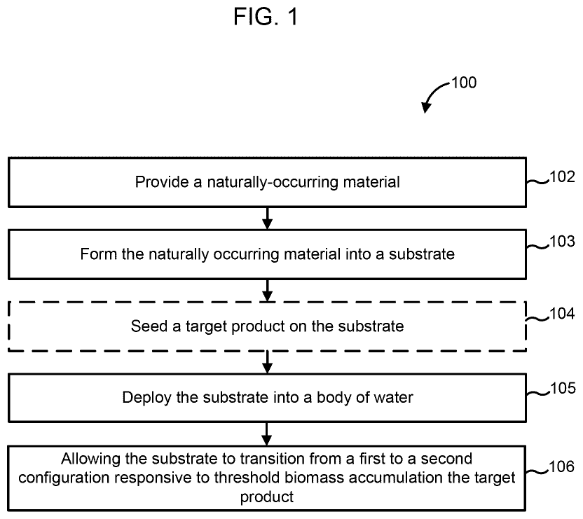

Referring now to the drawings, FIG. 1 is a flowchart of a method 101 for offshore cultivation of marine target products, according to an embodiment. The target product, as described herein, includes and/or encompasses a wide variety of species including microalgae, macroalgae, plankton, bacteria and other microorganisms, archaea filter feeders (such as oysters or clams), marine calcifiers, or any other target product described herein, either for the purpose of bioremediation, eventual cultivation/harvesting, mass transport (including floating, sinking, suspension, and lateral transport) and/or for capturing and sequestering carbon dioxide and related chemical species of carbon. The target products may generally include negatively, neutrally, and/or positively buoyant species (e.g., species that sink, remain suspended, or float in water as they grow). Such target products may propagate or reproduce by producing gametophytes and/or sporophytes that can rapidly grow in a body of water and sequester atmospheric carbon via photosynthesis and/or chemosynthesis.

The method 101 includes providing a naturally occurring material, at 102. The naturally occurring material may generally include an organic material that is readily available in natural environments, or is produced naturally as the main product or byproduct of farming or other cultivating/harvesting operations. For example, the naturally occurring material may include an agricultural waste product or a forest waste product. In various embodiments, the naturally occurring material may include, but is not limited to biomass (e.g., woody biomass) such as, for example, to grasses (e.g., switch grass, wild grass, genetically modified grass, etc.), wood chips (e.g., obtained from downed trees or wood reclamation operations), wood excelsior fibers, straw fibers, hog fuel, corn cobs, coconut shells, coconut fibers, hemp, jute, compost, mycelium, xanthum gum, agar, alginate, limestone (CaCO₃), dolomite (MgCa(CO₃)₂), dolostone, magnesite (MgCO₃), lime (CaO), slaked or hydrated lime (Ca(OH)₂), brucite (Mg(OH)₂), magnesium oxide (MgO), pumice (for buoyancy), alkaline mafic/ultramafic metal silicate minerals and/or rocks (to sequester CO₂ via ocean alkalinization and/or for buoyancy), naturally occurring carbonates and other salts, air or other compressed gas (for porosity, permeability, and/or buoyancy), any other suitable organic and/or inorganic product, waste product, and/or any combination(s) thereof. In some embodiments, the naturally occurring material may be a biobased material, or biodegradable polymer (e.g., polyhydroxyalkanoate based aliphatic polyesters) produced from natural materials such as sugar, oils, molasses, coconut oil, palm oil, chitin, etc. The naturally occurring materials (e.g., the biomass, biobased material, or biodegradable polymers) may be formulated to naturally biodegrade and/or dissolve in water (e.g., fresh or saltwater), for example, via hydrolysis and/or enzymatic digestion and/or to otherwise lose or gain buoyancy over time. In some embodiments, the naturally occurring material may be configured to degrade or dissolve in the body of water in a time period of about 50 days to about 500 days, inclusive of any period, range, or subrange therebetween.

At 103, the naturally occurring material is formed into a substrate, for example, a floating substrate that may be positively buoyant that allows the substrate to float on a water body, for example, an ocean, a sea, a river, a lake, a pond, etc., at least for a certain period of time or under certain environmental conditions. Thus, in some embodiments, the naturally occurring material may be naturally positively buoyant, such that the substrate formed therefrom may also be naturally positively buoyant.

The naturally occurring material may be formed into the substrate using any suitable means or process. In some embodiments, the substrate may be formed by forming the naturally occurring into a tube, or tube-like structure (e.g., a rope). For example, the naturally occurring material may be disposed in (e.g., stuffed within) one or more meshes, socks, over braids, spiral wraps, or any other tubular structures formed from a base layer so as to form a wattle, a slit sock, or a rope (e.g., similar to those used to prevent land erosion, or flood barriers), and/or formed in molds of beneficial geometries such as cubes, spheres, hemispheres, triangles, and/or other multisided shapes.

The base layer used to form the tube, or sock may be formed from the same material as the naturally occurring material, or a different material than the naturally occurring material. Regardless, the base layer may be formed from a biodegradable, dissolvable, and/or disaggregating material that may degrade at the same rate, or a different rate than the naturally occurring material. In various embodiments, the base material may include coconut fibers, wood excelsior fibers, straw fibers, natural twine, compost, or biobased biodegradable plastic perforated fabric, carbonates, minerals, rocks, gases, or mesh formed into a tubular structure.

In some embodiments, the naturally occurring material may be formed into a planar substrate. For example, the substrate may be formed by interposing the naturally occurring material between at least two sheets of a base layer, for example, any of the naturally occurring or biodegradable base layer(s) previously described herein. In various embodiments, the naturally occurring material may be formed into the planar substrate by stitching, weaving, laminating, or otherwise compressing between the two or more sheets (e.g., scrim fabrics, perforated sheets, meshes, rovings, etc.) to form the substrate (e.g., flat sheets or mats).

In some embodiments, the naturally occurring material may be formed into the substrate by disposed the natural-occurring material into a bag (e.g., a bag, a pouch, a bailer, or otherwise a container defining an internal volume) formed form a base material. The base material may be a biocompatible and/or a biodegradable and/or dissolving material, and may be the same as the naturally occurring material that is filled in the bag, or may be different therefrom. Examples of suitable base material include, but are not limited to coconut fibers, wood excelsior fibers, straw fibers, natural twine, compost, biobased biodegradable plastic perforated fabric, carbonates, rocks, minerals, gases, etc.

In some embodiments, the bag or otherwise container may be formed by weaving or sewing one or more base layers formed from the base material into the shape of a bag, pouch, bailer, etc., and disposing (e.g., stuffing or filling) the naturally occurring material into the inner volume defined by the bag, pouch, bailer, etc., to form the substrate. In some embodiments, the bag, pouch, bailer, etc., may be closed (e.g., by coupling together corresponding edges of the base layer forming the bag, pouch, or bailer, by sewing the edges together, or coupling via an adhesive such as a biodegradable adhesive). The base layers may be produced by forming the base materials into porous fabrics, sheets, or meshes, and forming bags, pouches, bailers, or otherwise containers using one or more of the base layers, as described herein. In some embodiments, the bags, or otherwise containers may have a symmetric shape (e.g., round, ovoid, polygonal, etc.). In other embodiments, the bags, or otherwise containers may have an asymmetric shape. In some embodiments, individual substrates may be combined to create larger forms, or may be subdivided to create smaller forms at any stage in the production and/or deployment of the substrate, either through natural and/or engineered processes.

In some embodiments, the naturally occurring material may be formed into the substrate without the use of base layers. For example, in some embodiments, the naturally occurring material may be compressed into a block having any suitable shape (e.g., circular, spherical, hemispherical, polygonal, or an asymmetrical shape) to form the substrate. In some embodiments, the substrate may be formed into a solid block that may be porous, for example, formed form strands, fibers, sheets, mats, or chunks of the naturally occurring material with space existing between the strands, fibers, sheets, mats, or chunks even after being compressed and may be bound with naturally occurring material(s) (e.g., reactive forms of any of the natural materials described herein) at the time of production, or cause to develop or lose porosity (e.g., multiple pores therewithin) through natural processes (e.g., via degradation or dissolution in the body of water) or engineered methods (e.g., subjecting the materials to mechanical forces or treating with chemicals such as acids). In some embodiments, the substrate may be formed into a hollow block defining an internal volume, for example, one or more internal voids or receptacles that may be formed by the injection and/or trapping of gases (e.g., air, nitrogen, and/or other gases). The hollow internal volume may trap air and/or other gases and may increase the buoyancy of the substrate.

In some embodiments, the naturally occurring material may be formed into the block shaped substrate by compressing a volume of the naturally occurring material (e.g., using a mechanical or hydraulic press) to form the block. For example, a predetermined volume of the naturally occurring material may be disposed in a mold, and pressure applied on the volume of the naturally occurring material to cause the volume of naturally occurring material to conform to the shape of the mold to form the substrate having a desired shape and or size. In some embodiments, the naturally occurring material may be mixed with an adhesive or binder before forming into the block, or an adhesive or binder may be poured over, or otherwise applied to the substrate after being formed into the block so as to cause the substrate to retain its shape. In such embodiments, the adhesive or binder may include a biocompatible, or otherwise biodegradable adhesive or binder, including, but not limited to beeswax, gelatin, molasses, tree sap, protein based polymers, alginate, xanthan gum, any suitable biodegradable polymer, as well as inorganic materials such as limestone (CaCO₃), dolomite (MgCa(CO₃)₂), dolostone, magnesite (MgCO₃), lime (CaO), slaked or hydrated lime (Ca(OH)₂), brucite (Mg(OH)₂), magnesium oxide (MgO), pumice (for buoyancy), alkaline mafic/ultramafic metal silicate minerals and/or rocks (e.g., to sequester CO₂ via ocean alkalinization and/or for buoyancy), naturally occurring carbonates and other salts, air or other compressed gas (for porosity, permeability, and/or buoyancy), and/or any combination(s) thereof. In some embodiments, the adhesive or binder may include of be spiked with nutrients, fertilizers, limiter other additives to promote growth of the target product and/or inhibit growth of deleterious products therein.

In some embodiments, the substrate may be configured to have a desired buoyancy. For example, a volume of the naturally occurring material used to form the substrate that includes a block, or an amount of pressure applied to the naturally occurring material may be varied to control the buoyancy of the substrate. For example, a higher volume of the material or a higher compression pressure may increase the density of the naturally occurring material, or reduce the porosity of the substrate that may positively or negatively impact the buoyancy of the substrate. In some embodiments, an amount or type of binder or adhesive used to form the substrate may be adjusted to control the buoyancy of the substrate. Similarly, the amount or type of natural material may be selected and/or designed to control the buoyancy of the substrate.

In some embodiments, the natural material(s) forming the substrate may be selected and/or designed to have a density in a range of about 0.020 g/cm³ to about 2 g/cm³ inclusive of any density or range of densities therebetween (e.g., 0.020 g/cm³, 0.040 g/cm³, 0.060 g/cm³, 0.080 g/cm³, 0.10 g/cm³, 0.12 g/cm³, 0.14 g/cm³, 0.16 g/cm³, 0.18 g/cm³, 0.20 g/cm³, 0.25 g/cm³, 0.30 g/cm³, 0.35 g/cm³, 0.40 g/cm³, 0.45 g/cm³, 0.50 g/cm³, 0.55 g/cm³, 0.60 g/cm³, 0.65 g/cm³, 0.70 g/cm³, 0.75 g/cm³, 0.80 g/cm³, 0.85 g/cm³, 0.90 g/cm³, 0.95 g/cm³, 1.00 g/cm³, 1.10 g/cm³, 1.20 g/cm³, 1.30 g/cm³, 1.40 g/cm³, 1.50 g/cm³, 1.60 g/cm³, 1.70 g/cm³, 1.80 g/cm³, 1.90 g/cm³, or 2.00 g/cm³, inclusive of any density or range of densities therebetween). In some embodiments, the natural material(s) forming the substrate may be selected and/or designed to have a porosity in a range of about 10% to about 90% (inclusive of any porosity or range of porosities therebetween) of the total volume of the substrate (e.g., 10%, 20%, 30%, 40%, 50%, 60%, 70%, 80%, or 90% (inclusive) of the total volume of the substrate).

In some embodiments, a substrate formed by such natural material(s) can have a density in any desirable range. For example, in some embodiments, a substrate in a first configuration can have a density of less than about 1.00 g/cm³ and in the second configuration can have a density of greater than about of about 1.03 g/cm³. In this manner, the substrate in the first configuration is configured to float in the body of water in which it is deployed (e.g., in saltwater found in a sea or ocean having a density of about 1.026 g/cm³) and in the second configuration is configured to sink in the body of water. In some embodiments, a substrate formed by the natural material(s) described above can have a porosity in a range of about 10% to about 90% of the total volume of the substrate, inclusive of all values and ranges therebetween.

In some embodiments, as previously described, the naturally occurring material may include a biobased material, or biodegradable polymer (e.g., polyhydroxyalkanoate based aliphatic polyesters) produced from natural materials such as sugar, oils, molasses, coconut oil, palm oil, chitin, etc. In such embodiments, the biobased materials may be formed into the substrate (e.g., a solid or hollow block having any suitable shape or size) by thermoplastic or molding techniques such as, for example, spray molding, blow molding, casting, injection molding, any other suitable manufacturing process, or a combination thereof. An amount, density, or composition of the biobased materials may be adjusted to control the buoyancy of the substrate formed therefrom.

Referring again to FIG. 1, in some implementations, the substrate optionally may be seeded with a target product before being deployed in the body of water (i.e., is pre-seeded), at 104. In some embodiments, the target product (e.g., gametophytes or sporophytes, or plantlets of marine algae, or any other target product described herein or biological component thereof) are seeded directly into the naturally occurring material that is included in the substrate, for example, any of the substrates previously described herein. In some embodiments, the target product may be seeded into the naturally occurring material before forming the naturally occurring material into the substrate. For example, the target product may be seeded into the naturally occurring material before the naturally occurring material is formed into a block, disposed into a tube, disposed between one or more sheets to form a planar substrate, or inserted into a bag. In other embodiments, the target product may be seeded into the naturally occurring material during and/or after the naturally occurring material is being and/or has been formed into a substrate. Seeding may be performed by disposing the target product in or on the naturally occurring product before the substrate is formed, during formation of the substrate, or after formation of the substrate, or by immersing the substrate in a volume of liquid (e.g., salt water, fresh water, culture medium, etc.) within which the target product is being grown or stored allowing a portion of the target product included in the volume of liquid to be become trapped in the pores of the substrate, thereby forming the seeded substrate.

In some implementations, the substrate may be configured to attract target product that may be naturally present in the body of water so as to become seeded with the target product after being deployed in the body of water. For example, the substrate may include and/or be formed from materials (e.g., any of the materials described herein) that attract the target product and/or cause the target product naturally present in the body of water to adhere to the substrate after being deployed in the body of water. Thus, the substrate may or may not be pre-seeded with the target product before being deployed in the body of water. In some implementations, the substrate may be pre-seeded and may, in addition, attract target products (or biological components thereof) naturally present in the body of water.

In some embodiments in which the naturally occurring material is formed into a substrate by disposing between or within base layers as previously described, the target product may be additionally, or alternatively, seeded in the base layer. For example, the target product may be seeded into a base layer shaped as a tube to form a tubular substrate, one or more planar base layers between which the naturally occurring material is disposed to form the planar substrate, or the one or more base layers structured to form a bag, as previously described. The target product may be mechanically trapped within the substrate, for example, within pores that may be present in the substrate or infused into the substrate. In some embodiments, the substrate may include a separate seeding layer disposed between the base layer(s) and the naturally occurring material included in the substrate. The seeding layer may be formed from a naturally occurring material or otherwise, a biocompatible or biodegradable material.

In some embodiments, the substrate (e.g., the naturally occurring product and/or the one or more base layers) may include binders or other materials to facilitate adhesion of the target product to the substrate. For example, cationic binders, hydrogels, adhesives, polymers, alginate, xanthan gum, pumice, minerals, rocks, or other seed binders may be included in the substrate to attract the target product (e.g., sporophytes, gametophytes, or plantlets) towards the substrate and keep the target product in proximity of the substrate until a strong adhesion or attachment is formed between the target product and the substrate. Other substances that may be used to enhance adhesion of the target product to the substrate may include, but are not limited to carbonate minerals containing ions that promote seed and/or holdfast binding, rheology modifiers, agglutinants, and other additives including glycerol, molasses, high molecular weight polysaccharides, and other polymeric materials such as polyethylene oxide.

In some embodiments, the substrate (e.g., the naturally occurring product and/or the base layer(s)) may include (e.g., spiked or infused with) nutrients, fertilizers, or other additives to promote growth of the target product therein. In some embodiments, such growth promoting additives may be provided in a dissolving material (e.g., formulated to naturally dissolve over a period of time in water) to allow timed release of nutrients. For example, one or more portions of the substrate (e.g., the naturally occurring material and/or the base layer) may be sprayed with a fertilizer formulated to accelerate growth of the species of target product. In some embodiments, the substrate may include additives formulated to suppress contamination of target product. For example, the substrate can include, be saturated or impregnated with, etc. a growth substrate material such as, for example, an enriched seawater medium, pasteurized seawater, filtrated seawater, seawater mixed with buffer solutions including but not limited to sodium nitrate (NaNO₃) solution, potassium dihydrogen phosphate (KH₂PO₄) solution, germanium dioxide (GeO₂), and/or the like. In some embodiments, the substrate may be infused with iron particles, or co-winded, coiled, and/or intertwined with an iron or an iron-containing thread, filament, or string to provide a source of iron (Fe) nutrient to the target product.

In some embodiments, one or more portions of the substrate may be inoculated with one or more diazotroph microorganisms including single-celled archaea organisms, bacteria such as cyanobacteria, azotobacter, rhizobia, Frankia, and/or the like (e.g., microbiota), capable of converting molecular nitrogen (N₂) from air into ammonia (NH₃) (e.g., fixing nitrogen). As previously described, the substrate (e.g., the naturally occurring material and/or the one or more base layers included in the substrate) may be porous. The porous nature of the substrate may provide passive release of the fertilizer, additives, growth promoters, or other substance infused therewithin overtime, thus providing continuous dosing of such substances to the seeded target product, and/or retain such substances in close proximity of the target product.

In some embodiments, instead of aggregating or combining the naturally occurring materials, or containing the naturally occurring material within a base layer(s) to form the substrate, and simultaneously or subsequently seeding the substrate with the target product, individual portions (e.g., strands, fibers, chunks, pieces, etc.) of the naturally occurring material may be prepared for coupling or adhering the target product thereto, for providing nutrition to the target product, promoting growth of the target product, and/or adjusting floating characteristics of the target product. Materials may be modified to provide one or more of the following benefits, for example: (1) slow water absorption through coating or treatment; (2) reduce density through drying; (3) modify surface to enhance biofilm and algae growth potential; (4) mechanically or electrostatically retain seed via seed binder (e.g., by simulating a biofilm); (5) seeding of the substrate; (6)including or providing a source fertilizers in the substrate; (7) adjusting buoyancy (e.g., floating or sinking), and/or lateral transportation of the product; (8) capturing and sequestering CO₂; and/or the like. For example, individual portions, or pieces of the naturally occurring product may be coated with or otherwise exposed to substances to adjust the buoyancy, and/or control nutrition provided, or growth characteristics of the target product via spray coating, dip coating, diffusion coating, tumble coating, electrolytic coating, and/or powder coating.

At 105, the substrate (e.g., a pre-seeded substrate or being devoid of target product (not yet naturally seeded)) is deployed into a body of water, for example, an ocean, a sea, a river, a pond, a lake, a river, a brine, or any other body of water. In some embodiments, the substrate may be seeded with the target product immediately before deployment in the body of water such that growth of the target product occurs substantially within the body of water. In some embodiments, the seeded target product may be allowed to grow or germinate for a period of time before deployment into the body of water, with subsequent growth of the seeded target product occurring in the body of water. Allowing the seeded target product to grow for the period of time may advantageously allow the target product to become integrated within the seeded substrate such that the seeded target product is inhibited from dissociating from the substrate when the seeded substrate is deployed into the body of water such that all or a significant portion of the seeded target product remains attached to or incorporated within the substrate after deployment. In some embodiments, the substrate may be deployed in the water without any target product embedded/seeded therein or otherwise attached thereto, and the substrate may be configured to attract and attach target product naturally present in the body of water thereto, as previously described.

In some embodiments, individual seeded substrates may be deployed independently in the body of water. In such embodiments, the seeded substrates may be relatively short in length. In some embodiments, multiple seeded substrates may be aggregated or otherwise coupled to each other to form an aggregate or array of seeded substrates that are deployed together in the body of water. Such aggregates or arrays may be formed by coiling, chaining (e.g., via twines, ropes, or chains), stacking, or coupling together in any suitable arrangement to form the aggregate. The aggregates may advantageously have higher or lower mechanical strength than individual seeded substrates. Moreover, forming aggregates may also advantageously at least partially shield adjacent seeded substrates included in the aggregate from the action of waves, currents, wind, herbivory, chemical oxidation, and/or sun damage, thereby inhibiting removal, erosion, deactivation, and/or breakage of the seeded target product, fertilizers, nutrients, additives, or binders from the seeded substrate.

At 106, the seeded substrate is allowed to transition from a first configuration to a second configuration in response to a threshold amount of biomass accumulation of the target product. In some embodiments, a buoyancy of the seeded substrate in the first configuration is greater than a threshold buoyancy and a buoyancy of the seeded substrate in the second configuration is less than the threshold buoyancy. In some embodiments, the buoyancy of the seeded substrate in the first configuration is less than a threshold buoyancy and a buoyancy of the seeded substrate in the second configuration is greater than the threshold buoyancy. In some other embodiments, the buoyancy of the seeded substrate in the first configuration is greater than a threshold buoyancy and a buoyancy of the seeded substrate in the second configuration is also greater than the threshold buoyancy, but may be greater than or less than the buoyancy in the first configuration. The threshold buoyancy may be based at least in part on a degree of negative buoyancy associated with the threshold amount of biomass accumulation. That is to say, a desired amount of biomass accumulation can dictate and/or at least partially determine the threshold buoyancy.

Expanding further, the naturally occurring product and the substrate formed therefrom is positively buoyant, i.e., floats in water as previously described. In contrast, the target product seeded in the substrate may be naturally negatively buoyant, i.e., sinks in water, or may become increasingly negatively buoyant as the target product matures. The buoyancy of the seeded substrate is therefore based on the buoyancy of the substrate and the buoyancy of the target product incorporated therein. In the first configuration, the seeded target product, which may or may not be partially grown before deployment in water, may have a first biomass having a first amount of negative buoyancy that is less than a first amount of positive buoyancy of the substrate. Thus, in the first configuration, the seeded substrate has an overall positive buoyancy such that the seeded substrate floats on the body of water when initially deployed. In some embodiments, the substrate may be negatively buoyant immediately upon deployment and used, for example, to anchor the upward-tending growing target product (e.g., due to air sacs or pneumatocysts) within the photic zone and to prevent it from floating away, to release the product from its anchor via dissolution, and/or through disaggregation of the substrate only once optimal growth has been achieved and the substrate is ready for transport and sinking in deeper waters, for example off of the continental shelf.

Over a period of time, the seeded target product accumulates biomass as it captures, absorbs, and/or sequesters atmospheric CO₂ and grows. The accumulation of biomass, in turn, increases an amount of negative buoyancy associated with the target product. Moreover, water may accumulate within the porous seeded substrate reducing the positive buoyancy of the substrate. Once a threshold amount of biomass of the target product is accumulated in the seeded substrate, the threshold amount of biomass may have a second amount of negative buoyancy that is greater than the first amount of positive buoyancy of the substrate, causing the seeded substrate (substrate+target product) to have a buoyancy that is less than the threshold buoyancy, which is based at least in part on the degree or amount of negative buoyancy associated with the threshold amount of biomass accumulation. Thus, in the second configuration, the seeded substrate may sink below surface carbon cycles (e.g., to the floor of the body of water), thereby trapping and/or sequestering the captured carbon within the body of water and/or within sediments (e.g., below the surface carbon cycles). Since the substrate includes naturally occurring materials and the target product includes naturally occurring organisms, the seeded substrate has a negligible impact on the environment (e.g., a marine environment), and, in some instances, may improve the environment by providing a nutrition source for animals and organisms that may reside near the floor or bottom of the body of water.

In some embodiments, the substrate may transition from the first configuration to the second configuration via removal or degradation of at least portions of the substrate. For example, the naturally occurring product included in the substrate, the one or more base layers included in the substrate, and/or the one or more binders included in the substrate may be naturally biodegradable (e.g., via hydrolysis and/or enzymatic digestion by organisms that may be naturally present in the water, may be degradable due to exposure to ultraviolet (UV) radiations of the sun) and/or may be dissolvable in water (e.g., includes calcium carbonate or other cementitious product that are dissolvable in water). Degradation of the substrate may occur over a period of time causing the positive buoyancy of the substrate to decrease, while the negative buoyancy of the target product seeded therein increases as it grows until the buoyancy of the substrate decreases to be less than the threshold buoyancy causing and/or otherwise allowing the seeded substrate to sink in the body of water.

In some embodiments, the substrate may be hollow (e.g., include or define a void or internal cavity therein) and a stopper, plug, or cap may seal the internal volume/cavity from the external environment. The stopper, plug, or cap may be configured to degrade over time, for example, via hydrolysis, chemical dissolution, disaggregation, UV radiation, and/or galvanic corrosion such that water may enter the internal cavity thereby, causing the buoyancy of the seeded substrate to decrease below the threshold buoyancy, as previously described. It should be appreciated that any of the substrates described herein may be configured to transition from the first configured to the second configuration using any combination of the transition mechanisms described herein with respect to the method 101.

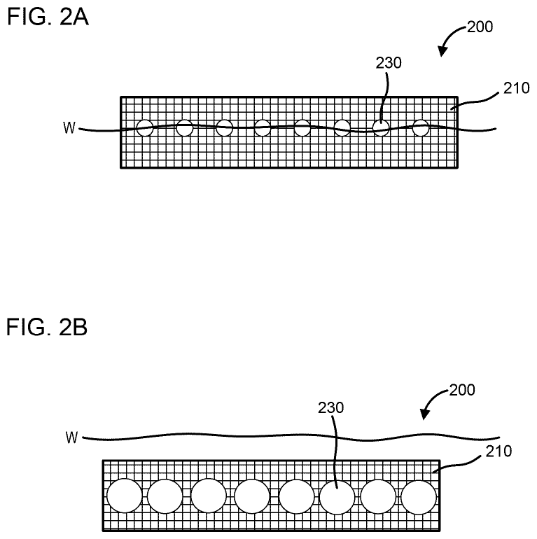

FIGS. 2A-8 show various examples of substrates or cultivation apparatus formed from naturally occurring materials, as described herein. For example, FIG. 2A is a schematic illustration of a cultivation apparatus 200 deployed on a body of water W, in a first configuration, and FIG. 2B is a schematic illustration of the cultivation apparatus 200 of FIG. 2A in a second configuration different from the first configuration, according to an embodiment.

The cultivation apparatus 200 includes a substrate 210 seeded with a target product 230 (e.g., any one of the target products described herein). The substrate 210 includes a naturally occurring material (e.g., any of the naturally occurring materials described herein) that is formed into a porous block within which the target product 230 is seeded. The naturally occurring material may be formed into the block by pressing the naturally occurring into block via application of mechanical or hydraulic force, or via a thermoplastic process. The substrate 210 may include fertilizer, additives, growth promoters, or other substances infused therein, and may include binders or adhesives, as previously described.

In the first configuration shown in FIG. 2A, the cultivation apparatus 200 has a first amount of buoyancy which is based on the combined buoyancy of the substrate 210 and the target product 230. As previously described, the substrate 210 may be positively buoyant and the seeded target product 230 may be negatively buoyant or may become negatively buoyant as the target product 230 matures. However, in the first configuration, a relatively small biomass of the target product 230 is such that a magnitude of the negative buoyancy of the target product 230 is less than a magnitude of the positive buoyancy of the substrate 210. As such, the cultivation apparatus 200 has a buoyancy that is greater than a threshold buoyancy causing the cultivation apparatus 200 to float on the body of water W in the first configuration.

As the target product 230 grows within the substate 210, it absorbs, captures, and/or sequesters carbon while accumulating biomass. Once a threshold amount of biomass is accumulated, the cultivation apparatus 200 transitions into the second configuration in which the negative buoyancy of the target product 230 overcomes the positive buoyancy of the substrate 210 causing the buoyancy of the cultivation apparatus 200 to become less than the threshold buoyancy. This causes the cultivation apparatus 200 to sink below the surface of the body of water W as shown in FIG. 2B, thereby sequestering carbon from the atmosphere that is captured or absorbed by the target product by trapping it within the body of water W (e.g., below the surface carbon cycles), and is in addition to the CO₂ sequestered through the formation, transformation, and/or dissolution of the substrate and/or coatings, binders, etc. thereof.

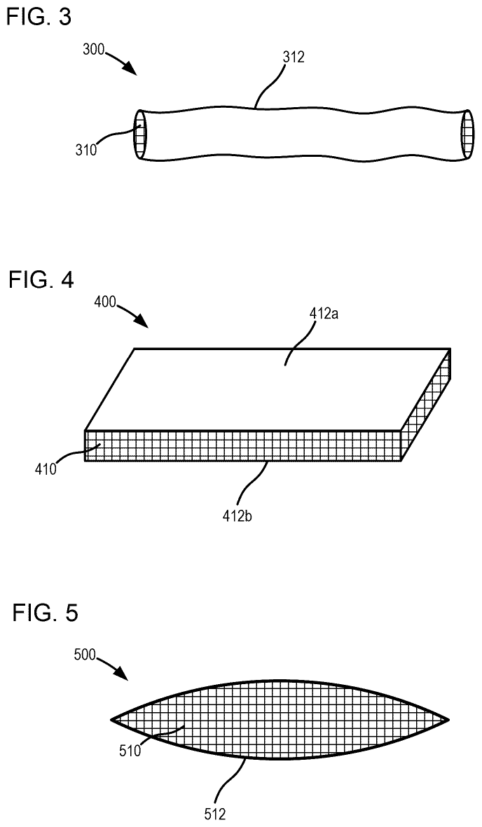

FIG. 3 is a schematic illustration of a cultivation apparatus 300 or substrate configured to have a tubular shape, according to an embodiment. The cultivation apparatus includes a base layer 312 that is shaped in the form of a tube or sock and defines an internal volume in which naturally occurring material 310 (e.g., any of the naturally occurring materials described herein) is disposed. The base layer 312 may be formed from the same material as the naturally occurring material 310 or a different material(s) therefrom. For example, the base layer 312 may be formed from a biodegradable material that may degrade at the same rate, or a different rate than the naturally occurring material 310. In various embodiments, the base layer 312 may include coconut fibers, wood excelsior fibers, straw fibers, natural twine, compost, or biobased biodegradable plastic perforated fabric or mesh formed into a tubular structure.

The base layer 312 may be formed into the tubular shape (e.g., a tube, a sock an over braid, a spiral wrap, a wattle, a rope, or any other suitable tubular shape) by sewing, wrapping, intertwining, braiding, mineralizing, or any other suitable process. In some embodiments, axial ends of the base layer 312 may be open. In other embodiments, axial ends of the base layer 312 may be closed. The target product (e.g., any of the target products described herein) may be seeded within the naturally occurring material 310 and/or the base layer 312, as previously described herein. Moreover, the cultivation apparatus 300 (e.g., the naturally occurring material 310 and/or the base layer 312) may be infused with, injected with, coated with, or otherwise may include fertilizer, additives, growth promoters or inhibitors, or other substances infused therein, and may include binders, adhesives, and/or aggregates as previously described, to promote growth and retention of the target product therein. The cultivation apparatus 300 is configured to transition from a first configuration in which the cultivation apparatus 300 has a buoyancy greater than a threshold buoyancy into a second configuration in which the cultivation apparatus 300 has a buoyancy less than the threshold buoyancy due to accumulation of biomass as the target product grows after the cultivation apparatus 300 is deployed in a body of water, as described with respect to the cultivation apparatus 200. More specifically, the buoyancy of the cultivation apparatus 300 in the second configuration can be such that the cultivation apparatus 300 is allowed to sink to the bottom of the body of water.

FIG. 4 is a schematic illustration of a cultivation apparatus 400 or substrate configured to have a substantially planar shape, according to an embodiment. The cultivation apparatus 400 includes a naturally occurring material 410 (e.g., any of the naturally occurring materials described herein) interposed between a first base layer 412a and a second base layer 412b such that cultivation apparatus 400 has a substantially planar or sheet shape. The base layers 412a/b may be formed from the same material as the naturally occurring material 410 or a different material therefrom. In various embodiments, the naturally occurring material 410 may be secured or contained between the first and second base layers 412a and 412b by stitching, weaving, laminating, or otherwise compressing the first and second base layers 412a and 412b (e.g., scrim fabrics, perforated sheets, meshes, rovings, etc.) with the naturally occurring material interposed therebetween to form the cultivation apparatus 400 (e.g., a flat sheet(s) or mat(s)).

The target product (e.g., any of the target products described herein) may be seeded within the naturally occurring material 410, and/or the first base layer 412a, and/or the second base layer 412b, as previously described herein. Moreover, the cultivation apparatus 400 (e.g., the naturally occurring material 410 and/or the base layers 412a/b) may be infused with, injected with, coated with, or otherwise may include fertilizer, additives, growth promoters and/or inhibitors, or other substances infused therein, and may include binders, adhesives, and/or aggregates to increase or decrease buoyancy (e.g., CaCO₃, pumice, metal oxides, and/or alkali metal silicates) as previously described to promote growth and retention of the target product therein. The cultivation apparatus 400 is configured to transition from a first configuration in which the cultivation apparatus 400 has a buoyancy greater than a threshold buoyancy into a second configuration in which the cultivation apparatus 400 has a buoyancy less than the threshold buoyancy due to accumulation of biomass as the target product grows after the cultivation apparatus 400 is deployed in a body of water, as described with respect to the cultivation apparatus 200, 300. More specifically, the buoyancy of the cultivation apparatus 400 in the second configuration can be such that the cultivation apparatus 400 is allowed to sink to the bottom of the body of water.

FIG. 5 is a schematic illustration of a cultivation apparatus 500 or a substrate including a bag, according to an embodiment. The cultivation apparatus 500 includes a naturally occurring material 510 (e.g., any of the naturally occurring material described herein) that is disposed or contained within a base layer(s) 512 shaped as and/or otherwise forming a bag (e.g., a bag, a pouch, a bailer, or otherwise a container defining an internal volume). The base layer(s) 512 may include a biocompatible and/or a biodegradable material, and may be the same as the naturally occurring material 510 that is contained within the base layer 512, or may be different therefrom, for example, as described with respect to the base layer 312, 412a, 412b, or any other base layer described herein.

In some embodiments, the base layer(s) 512 may be formed into the bag or pouch by coupling together corresponding edges of base layer(s) 512, for example, by sewing edges of the base layer(s) 512 together, or via an adhesive such as a biodegradable adhesive. The base layer(s) 512 may be produced by forming naturally occurring, biocompatible, and/or biodegradable materials into porous fabrics, sheets, or meshes, that are then formed into bags, pouches, bailers, or otherwise containers.

While FIG. 5 shows the cultivation apparatus 500 as having an ovoid shape, in other embodiments, the cultivation apparatus 500 can have any other suitable shape, for example, spherical, polygonal, or asymmetrical. The target product (e.g., any of the target products described herein) may be seeded within the naturally occurring material 510, and/or the base layer(s) 512, as previously described herein. Moreover, the cultivation apparatus 500 (e.g., the naturally occurring material 510 and/or the base layer(s) 512) may be infused with, injected with, coated with, or otherwise may include fertilizer, additives, growth promoters and/or inhibitors, or other substances infused therein, and may include binders, adhesives, and/or aggregates to increase or decrease buoyancy (e.g., CaCO₃, pumice, metal oxides, and/or alkali metal silicates) as previously described to promote growth and retention of the target product therein. The cultivation apparatus 500 is configured to transition from a first configuration in which the cultivation apparatus 500 has a buoyancy greater than a threshold buoyancy into a second configuration in which the cultivation apparatus 500 has a buoyancy less than the threshold buoyancy due to accumulation of biomass as the target product grows after the cultivation apparatus is deployed in a body of water, as described with respect to the cultivation apparatus 200, 300, 400. More specifically, the buoyancy of the cultivation apparatus 500 in the second configuration can be such that the cultivation apparatus 500 is allowed to sink to the bottom of the body of water.

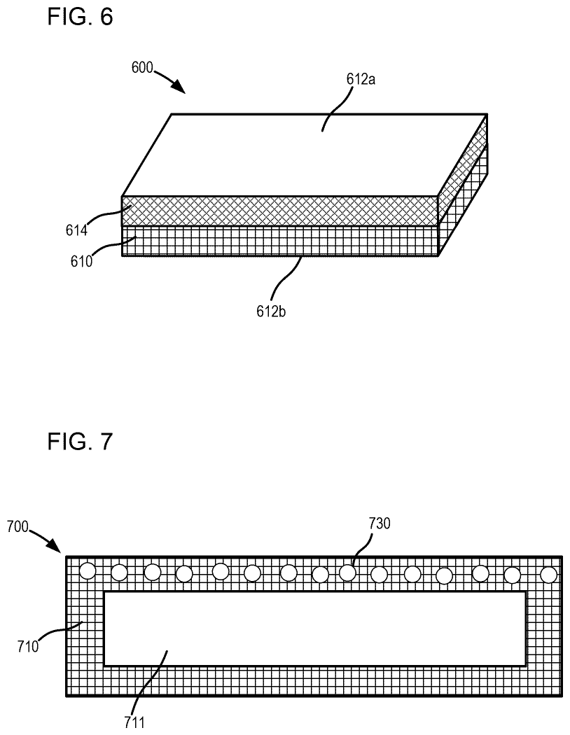

FIG. 6 is a schematic illustration of a cultivation apparatus 600 or substrate including a seeding layer, according to an embodiment. Similar to the cultivation apparatus 400, the cultivation apparatus 600 includes a first base layer 612a and a second base layer 612b, as described with respect to the first base layer 412a and the second base layer 412b. A naturally occurring material 610 (e.g., the naturally occurring material 410 or any other naturally occurring material described herein) is disposed between the first base layer 612a and the second base layer 612b.

Different from the cultivation apparatus 400, however, the cultivation apparatus 600 also includes a seeding layer 614 interposed between the first base layer 612a and the naturally occurring material 610. In some embodiments, a seeding layer may additionally, or alternatively, be disposed between the naturally occurring material 610 and the second base layer 612b. In other embodiments, the seeding layer 614 can be interposed between two layers of the naturally occurring material 610. The target product (e.g., any of the target products described herein) are seeded in the seeding layer 614. The seeding layer 614 may also be formed from a naturally occurring material (e.g., the same as or different from the naturally occurring material 610), or may be formed from a biodegradable material (e.g., a hydrogel, a biobased polymer, certain aliphatic polyesters, etc.).

In some embodiments, the seeding layer may include limestone (CaCO₃), dolomite (MgCa(CO₃)₂), dolostone, magnesite (MgCO₃), lime (CaO), slaked or hydrated lime (Ca(OH)₂), brucite (Mg(OH)₂), magnesium oxide (MgO), pumice, alkaline mafic and/or ultramafic metal silicate minerals and/or rocks, naturally occurring carbonates and/or other salts, air and/or other compressed gas, and/or any suitable combinations thereof. Such components or materials may support and/or deter biotic attachments by modifying surface chemistry, free energy, topography, and/or texture in support and/or deterrence of biotic settlement, recruitment and/or growth through, for example, the release of free calcium ions that promote adhesion of polysaccharide adhesives in the holdfasts of macroalgae. In some embodiments, the naturally occurring material 610 included in the cultivation apparatus 600 may only serve to provide positive buoyancy to the cultivation apparatus 600, while the seeding layer 614 may also be infused with fertilizer, additives, growth promoters, binders, adhesives, or any other substances formulated to facilitate adhesion and/or growth of the target product. In some embodiments, fertilizer, additives, growth promoters and/or inhibitors, binders, adhesives, or any other substance to facilitate adhesion or growth of the target product may additionally, or alternatively, be infused in the naturally occurring material 610 and/or the base layers 612a/b.

The cultivation apparatus 600 is configured to transition from a first configuration in which the cultivation apparatus 600 has a buoyancy greater than a threshold buoyancy into a second configuration in which the cultivation apparatus 600 has a buoyancy less than the threshold buoyancy, for example, due to accumulation of biomass as the target product grows after the cultivation apparatus is deployed in a body of water, as described with respect to the cultivation apparatus 200, 300, 400, 500. More specifically, the buoyancy of the cultivation apparatus 600 in the second configuration can be such that the cultivation apparatus 600 is allowed to sink to the bottom of the body of water.

FIG. 7 is a schematic illustration of a cultivation apparatus 700 including a hollow substrate, according to an embodiment. The cultivation apparatus 700 includes a naturally occurring material 710 formed into a block similar to the cultivation apparatus 200. However, different from the cultivation apparatus 200, the cultivation apparatus 700 is hollow and defines an internal volume 711, which may be selectively or at least temporarily filled with air and/or other gases. A target product 730 (e.g., any of the target products described herein) is seeded in the naturally occurring material 710. While FIG. 7 shows the target product as being seeded only in one portion of the naturally occurring material 710, in some embodiments, the naturally occurring material 710 may be uniformly seeded with the target product 730 or may be seeded in one or more separate portions or areas.

While FIG. 7 shows the cultivation apparatus 700 having a single internal cavity 711, in other embodiments, the cultivation apparatus 700 may have any number of internal cavities or receptacles. The one or more of the internal cavities 711 may contain air and/or other gases that may beneficially enhance the positive buoyancy of the cultivation apparatus 700 and reduce the amount of naturally occurring material 710 used to form the cultivation apparatus 700, thereby reducing material usage and cost. The cultivation apparatus 700 (e.g., the naturally occurring material 710 or at least a portion or area thereof) may be infused with, injected with, coated with, or otherwise may include fertilizer, additives, growth promoters, or other substances infused therein, and may include binders or adhesives, as previously described to promote growth and retention of the target product therein.

The cultivation apparatus 700 is configured to transition from a first configuration in which the cultivation apparatus 700 has a buoyancy greater than a threshold buoyancy into a second configuration in which the cultivation apparatus 700 has a buoyancy less than the threshold buoyancy due to accumulation of biomass as the target product grows after the cultivation apparatus is deployed in a body of water. Additionally, or alternatively, water may slowly penetrate or absorb through the naturally occurring material 710 into the internal volume 711 over a period of time after deployment of the cultivation apparatus 700 in the body of water, for example, due to natural porosity of the naturally occurring material 710 or an increase in the natural porosity due to degradation or the like. As the internal volume 711 fills with water over a period of time, the buoyancy of the cultivation apparatus 700 reduces until the buoyancy becomes less than the threshold buoyancy causing and/or allowing the cultivation apparatus 700 to sink into the body of water below the surface carbon cycles, as previously described.

In some embodiments, the cultivation apparatus 700 may be structured such that the internal volume 711 is sealed from the external environment (e.g., hermetically or substantially hermetically sealed), for example, by incorporating binders or sealants in the naturally occurring material 710 or in at least an internal surface of the naturally occurring material 710. In such embodiments, the transitioning of the cultivation apparatus 700 from the first to the second configuration may be caused substantially by the accumulation of biomass because of growth of the target product, and/or natural degradation or disintegration of the naturally occurring material 710 over time that may allow water to enter the internal volume 711. This may cause the buoyancy of the cultivation apparatus 700 to decrease below the threshold buoyancy causing and/or allowing the cultivation apparatus 700 including the target product 730 to sink below the surface of the body of water.

Although not shown in FIG. 7, in some embodiments, the cultivation apparatus 700 optionally can include a stopper, plug, or cap configured to seal the internal volume 711 from the external environment. The stopper, plug, or cap may be configured to degrade over time, for example, via hydrolysis, UV radiation, chemical dissolution, and/or galvanic corrosion such that water may enter the internal cavity 711 thereby, causing the buoyancy of the cultivation apparatus 700 to decrease below the threshold buoyancy, as described above.

In some embodiments, any of the substrates described herein may be used in a cultivation apparatus as a flotation device, and separate portions of the cultivation apparatus may be used to seed the target product. Moreover, additional components to control buoyancy of the cultivation apparatus, monitor the buoyancy, monitor growth of the target product, and/or monitor and collect data on one or more operational parameters of the cultivation apparatus may be included in the cultivation apparatus.

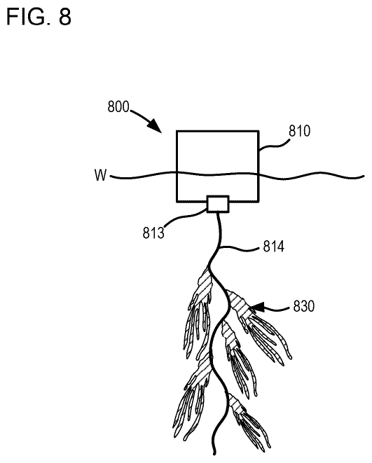

For example, FIG. 8 is a schematic illustration of a cultivation apparatus 800, according to an embodiment. In some implementations, the cultivation apparatus 800 can be used to cultivate one or more target products such as, for example, one or more macroalgae species and/or the like, or any other targe product described herein. In some implementations, the cultivation apparatus 800 or any of the substrates or cultivation apparatus described herein (e.g., the cultivation apparatus 200, 300, 400, 500, 600, 700) can be included in a deployment of tens, hundreds, thousands, tens of thousands, hundreds of thousands, or more cultivation apparatus. Every cultivation apparatus 800 (or any other cultivation apparatus described herein) in such a deployment has been seeded with and/or has attached thereto one or more target products.

As described in detail herein, the deployment of cultivation apparatus 800 can occur at any suitable geographical location on or in any suitable body of water. As shown in FIG. 8, the cultivation apparatus 800 includes a first member 810, a second member 814, and an intermediate member 813 configured to reversibly couple the first member 810 to the second member 814. The cultivation apparatus 800 and/or the first, second, and intermediate members thereof, can be any suitable shape, size, and/or configuration. In some embodiments, for example, the cultivation apparatus 800 can be substantially similar to any of the cultivation apparatus (also referred to as “microfarms”) described in detail in U.S. Patent Publication No. 2021/0345589, filed Jun. 8, 2021, entitled “Systems and Methods for the Cultivation of Target Product,” the disclosure of which is incorporated herein by reference in its entirety (referred to herein as the “'589 publication”). In some embodiments, the cultivation apparatus 800 can differ from the cultivation apparatus described in the '589 publication in that one or more of the naturally occurring materials described herein may be used to form at least portions of the cultivation apparatus. Moreover, the naturally occurring materials can be positively or negatively buoyant.

In some embodiments, the cultivation apparatus 800 can be arranged in a modular configuration in which one or more portions of the first member 810, the second member 814, and/or the intermediate member 813 can be mechanically coupled to collectively form the cultivation apparatus 800. For example, in some implementations, a second member 814 can be seeded with, be coupled to, and/or or attached to one or more target products (or a target product can be attached to the second member 814) at a delivery and/or deployment system. In such implementations, the one or more portions of the cultivation apparatus 800 can be loaded into the delivery and/or deployment system and/or a component thereof, transported to a deployment location, assembled (e.g., the first member 810, the second member 814, and the intermediate member 813 can be at least temporarily coupled) on the delivery and/or deployment system as the delivery and/or deployment system approaches and/or is at the deployment location, and then deployed into a body of water at or near the deployment location.

The first member 810 of the cultivation apparatus 10 can be any suitable shape, size, and/or configuration. In some embodiments, the first member 810 can be include the substrate or cultivation apparatus 200, 300, 400, 500, 600, 700, or any other substrate or cultivation apparatus described herein. For example, in some embodiments, the first member 810 of the cultivation apparatus 800 can include and/or can form a growth substrate or the like configured to be seeded with and/or otherwise receive a target product such as one or more species of macroalgae gametophytes and/or sporophytes, as previously described herein. In some embodiments, the first member 810 can be configured to provide buoyancy to the various components of the apparatus 800 (with or without being seeded with a target product), allowing the apparatus 800 to at least temporarily float on a surface, or at a desired depth of the body of water W in which it is deployed. In some implementations, the first member 810 can be retrieved after a predetermined time and/or after a desired amount of target product growth or accumulation. In other implementations, the first member 810 can be configured to sink after a predetermined time and/or after a desired amount of target product growth or accumulation.

In some embodiments, the first member 810 (e.g., a substrate, a “buoy,” and/or any other selectively buoyant member), is formed from a naturally occurring material, for example, any of the naturally occurring materials described herein. In some embodiments, the first member 810 (e.g., in the form of hollow block as described with respect to the cultivation apparatus 700) can include a mechanical, chemical, and/or biological timer/valve configured to release gas contained therein after a predetermined time (e.g., a time associated with and/or allowing for a desired amount of target product growth and/or accumulation), thereby reducing the buoyancy of the first member 810. In some embodiments, the first member 810 (e.g., any of the cultivation apparatus 200, 300, 400, 500, 600, or 700) or at least a portion thereof can be configured to partially or completely degrade and/or decompose after a threshold period of being deployed (e.g., in or on an ocean, etc.) and/or in response to or after the cultivation apparatus 800 sinking to the sea/ocean bottom. In some embodiments, the first member 810 can include one or more portions that can degrade and/or decompose at different rates and/or at variable rates in response to environmental conditions.

In some embodiments, the first member 810 can include a sealing member at least temporarily coupled to and/or at least temporarily disposed in the first member 810. In some implementations, the sealing member can be degradable and/or dissolvable and/or can be automatically or manually decoupled from the first member 810, thereby allowing the air and/or other gases contained therein to escape, and/or allow water to enter the first member 810 (e.g., as described with respect to the cultivation apparatus 700). As such, the first member 810 (and thus, the cultivation apparatus 800) can be positively buoyant when initially deployed, allowed to float for a predetermined and/or threshold time after being deployed, and then allowed to sink as a target product seeded on or attached to the cultivation apparatus 800 grows and obtains biomass (e.g., as described in detail herein as well as in the '589 publication), and/or vice versa (e.g., anchoring in shallow waters within a photo zone followed by buoyant release).

The second member 814 of the cultivation apparatus 800 can be any suitable shape, size, and/or configuration. The second member 814 can be coupled to the first member 810 and/or the intermediate member 813 (e.g., at a desired deployment location). In some embodiments, the second member 800 can be similar to and/or substantially the same as any of the second members of the cultivation apparatuses described in the '589 publication. For example, in some embodiments, the second member 814 can be one or more seeding lines, longlines, ropes, and/or the like. In some embodiments, the second member 814 can be similar to any of the substrates and/or can be formed from any of the naturally occurring materials described herein. In some embodiments, the second member 814 can include optional weight(s) such as metallic rings, mineralized layers, and/or the like (not shown) to provide negative buoyancy of and/or associated with the second member 814.

In some implementations, the second member 814 can be configured to receive one or more species of a target product 830 such as one or more species of macroalgae gametophytes and/or sporophytes, or any other target product described herein. For example, one or more portions and/or surfaces of the second member 814 can be formed of, include, and/or be coupled to a growth substrate (not shown) and/or can be formed of any of the naturally occurring materials described herein, which in turn, is infused with a growth substrate, nutrients, fertilizers, binders, additives, and/or the like configured to facilitate seeding, attachment, and/or growth of a target product, as described above.

The intermediate member 813 of the cultivation apparatus 800 can be any suitable shape, size, and/or configuration. In some embodiments, the intermediate member 813 can be similar to and/or substantially the same as any of the intermediate members of the cultivation apparatuses described in the '589 publication. For example, in some embodiments, the intermediate member 813 can be similar, at least in part, to the first member 810 and/or second member 814. The intermediate member 813 is configured to couple at least temporarily the first member 810 to the second member 814. For example, one or more portions of the intermediate member 813 can be and/or can include an adhesive, glue, paste, cement, etc. ; one or more mechanical linkages such as ring(s), shackle(s), swivel(s), joint(s), and/or the like; one or more anchor points such as tie knot(s), thimble kit(s), hook(s), and/or the like; and/or any other suitable coupling.

In some embodiments, the intermediate member 813 can be formed of a degradable material, a compostable co-polyester, a cellulose-based material, any of the naturally occurring materials described herein, and/or the like. For example, the intermediate member 813 can be formed of and/or can include polyglycolide, polylactide, polyhydroxobutyrate, chitosan, hyaluronic acid, poly(lactic-co-glycolic), poly (caprolactone), polyhydroxyalkanoate, Ecoflex™, Ecovio®, and/or any other ocean compatible material(s) and/or combinations thereof. In some embodiments, the intermediate member 813 can be formed of any of the materials and/or combination of materials described, for example, in the '589 publication. In some embodiments, the intermediate member 813 may be formed from a naturally occurring material (e.g., any of the naturally occurring materials described herein). While examples of materials (e.g., degradable and/or compostable materials) are listed, it should be understood that other materials are possible, and the materials are not intended to be limited to those stated and/or referenced herein.

As described above with reference to the first member 810, the intermediate member 813 can be configured to degrade after a threshold or predetermined time of being deployed. In some implementations, the degrading of the intermediate member 813 can allow and/or can result in a decoupling of the first member 812 from the second member 814. In some embodiments, the intermediate member 813 can be configured to degrade after a desired amount of growth or accumulation of the target product 830 attached to the second member 814, as described above. In some embodiments, the intermediate member 813 can be configured to degrade under predetermined environmental conditions including but not limited to temperature, pressure, exposure to UV and/or visible light, physical disturbance, acid-base chemistry, and/or the like.

As described above, in some implementations, the first member 810 can be positively buoyant, while the second member 814 can be negatively buoyant and/or the target product 830 attached to the second member 814 can be negatively buoyant. Thus, when the intermediate member 813 decouples the first member 810 from the second member 814 (e.g., as a result of degrading or as a result of a mechanical decoupling), the first member 810 can float at or on a surface of the ocean, while the second member 814 and the target product 830 attached thereto can sink to the bottom or floor of the body of water (e.g., seafloor, ocean floor, etc.). The sinking of the second member 814 and the target product 830 attached thereto effectively sequesters an amount of carbon associated with and/or captured by the target product 830.

In some embodiments, the second member 814 can be formed from the naturally occurring material described herein and may naturally degrade (e.g., after sinking). In some embodiments, the first member 810 that is formed from the naturally occurring material may also be naturally degradable, or configured to degrade and/or otherwise decompose on the surface of the water or can be configured to degrade and sink to the bottom or floor of the body of water. In some embodiments, the first member 810 may degrade at a slower rate than the intermediate member 813 such that the degradation or otherwise decomposition of the intermediate member 813 causes detachment and sinking of the second member 814 and thereby, the target product 830.

In some embodiments, the cultivation apparatus 800 and/or one or more components thereof (e.g., the first member 810) can include and/or can be coupled to device(s) configured to sense, detect, and/or monitor growth of the target product 830, biomass generation, biomass yield, environmental characteristics or data, and/or any other data associated with a deployment of one or more cultivation apparatus. For example, in some embodiments, the cultivation apparatus 800 can include one or more sensors, cameras (e.g., underwater cameras and/or other imaging technologies), tracking devices (e.g., a Global Positioning System (GPS) tracking device, a Radio-Frequency Identification (RFID) device, and/or the like), remote sensing devices, telemetry devices, and/or any other suitable device such as any of those described in the '589 publication, U.S. patent application Ser. No. 17/957,681 (“the '681 application”), filed Sep. 30, 2022, entitled, “Systems and Method for Quantifying and/or Verifying Target Product Accumulation for Greenhouse Gas Sequestration,” and/or U.S. patent application Ser. No. 18/156,615 (“the '615 application”), filed Jan. 19, 2023, entitled, “Systems and Methods for Monitoring Accumulation of a Target Product,” the disclosures of which are incorporated herein by reference in their entireties.

In some implementations, including such device(s) in or coupling such device(s) to the buoyant first member 810 can allow the retrieval of the first member 810 and device(s) after, for example, the second member 814 has been decoupled from the first member 810. In such implementations, the first member 810 can be formed from any of the naturally occurring materials described herein but can be treated and/or otherwise configured to delay, reduce, and/or substantially prevent degradation, thereby allowing retrieval of the first member 810 (e.g., after being decoupled from the second member 814). As such, data associated with and/or collected at or by the cultivation apparatus 800 can be aggregated, analyzed, calculated, processed, etc. to allow for a determination, estimation, and/or prediction of, for example, historical or current target product growth or growth rates, biomass production, biomass yield, sinking rate(s), location(s) of a deployment, dispersion of a deployment, environmental conditions in an area corresponding to a deployment, and/or any other desired information associated with the cultivation apparatus 800 and/or a deployment of any number of cultivation apparatus. Moreover, in some implementations, such information can be used and/or can otherwise inform one or more predictions and/or quantifications associated with carbon capture and/or sequestration rates, quantities, capacities, and/or the like, as described in detail in the '589 publication. In some embodiments, the data collected by such devices may be wireless transmitted to remote data collection centers, for example, located on shore, or on boats, buoys, or drones floating in proximity of the location on the body of the water where aggregates or arrays of the cultivation apparatus 800 are deployed. In such embodiments, the device(s) may also be formed form biocompatible materials, such that device(s) sink into the body of water with the cultivation apparatus, and can eventually degrade or decompose in the body of water.

As described above, the cultivation apparatus 800 can be seeded with one or more species of a target product such as macroalgae, and then deployed in a body of water such as an ocean, sea, lake, river, brine, etc. In some instances, the hatching and/or the seeding of one or more components of the cultivation apparatus 800 can be initiated at an onshore hatchery facility and/or the like. The components of the cultivation apparatus 800 can then be transferred, included, and/or incorporated into a delivery and/or deployment system. The delivery and/or deployment system can be configured to receive, house, and/or accommodate the components of the cultivation apparatus 800, provide the conditions suitable for further development of the seeded target product(s), transport the components of the cultivation apparatus 800 to a geographical location suitable for deployment, and facilitate rapid assembly of the cultivation apparatus 800 and subsequent deployment. In other instances, the hatching and/or the seeding of one or more components of the cultivation apparatus 800, as well as their subsequent development, transportation and deployment can be performed at or on the delivery and/or deployment system (e.g., a vessel).

It is important to note that the construction and arrangement of the various embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the any of the teachings and/or advantages of the subject matter described herein. Other substitutions, modifications, changes, and/or omissions may also be made in the design, operating conditions, and/or arrangement of the various embodiments without departing from the scope of the disclosure. Where schematics and/or embodiments described above indicate certain components arranged in certain orientations or positions, the arrangement of components may be modified.

While this specification contains many specific implementation details, these should not be construed as limitations on the scope of any embodiments or use of embodiments, or of what may be claimed, but rather as descriptions of features or aspects specific to particular implementations. Certain features and/or aspects described in this specification in the context of separate implementations can also be implemented in combination in a single implementation. Conversely, various features and/or aspects described in the context of a single implementation can also be implemented in multiple implementations separately or in any suitable subcombination. Moreover, although features may be described above as acting in certain combinations and even initially claimed as such, one or more features from a combination can in some cases be excised from the combination to define and/or form a subcombination or variation of a subcombination thereof.

Thus, while particular implementations have been described, other implementations are within the scope of the disclosure and the appended claims. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
forming a naturally occurring material into a substrate;
seeding the substrate with a target product;
deploying the substrate into a body of water;
allowing the target product to grow in the body of water and accumulate biomass;
allowing the substrate to transition from a buoyant configuration in which the substrate floats on the surface of the water, to a non-buoyant configuration in which the substrate sinks to the bottom of the body of water.

2. The method of claim 1, wherein the substrate transitions to the non-buoyant configuration as a result of at least a threshold amount of biomass accumulation.

3. The method of claim 1, wherein the naturally occurring material is an agricultural product.

4. The method of claim 1, wherein the naturally occurring material is a forest product.

5. The method of claim 1, wherein the forming the naturally occurring material into the substrate includes interposing the naturally occurring material between at least two sheets of a base layer.

6. The method of claim 1, wherein the forming the naturally occurring material into the substrate includes disposing the naturally occurring material into a bag formed of a base material.

7. The method of claim 1, wherein the forming the naturally occurring material into the substrate includes disposing the naturally occurring material into a tube formed of a base material.

8. The method of claim 1, wherein the target product is macroalgae

9. The method of claim 1, further comprising:
determining an amount of carbon sequestered by the sinking of the macroalgae.

10. The method of claim 9, further comprising:
selling a carbon credit associated with the amount of carbon sequestered by the macroalgae.

11. A method, comprising:
seeding a substrate with macroalgae, the substrate comprising a naturally occurring material;
deploying the substrate into in a body of water;
allowing the macroalgae to grow in the body of water and accumulate biomass;
allowing the naturally occurring material to degrade after a period of time, the period of time being sufficient to allow the macroalgae to grow in the body of water and accumulate a threshold amount of biomass, the degradation of the naturally occurring material causing the substrate to passively lose buoyancy;
allowing the macroalgae and the substrate to sink to a floor of the body of water as a result of the degradation of the naturally occurring material.

12. The method of claim 11, wherein the naturally occurring material is at least one of grasses, wood chips, hog fuel, corn cobs, coconut shells, coconut fibers, hemp, jute, compost, xanthum gum, agar, alginate, limestone (CaCO₃), dolomite (MgCa(CO₃)₂), dolostone, magnesite (MgCO₃), lime (CaO), slaked or hydrated lime (Ca(OH)₂), brucite (Mg(OH)₂), magnesium oxide (MgO), pumice, alkaline mafic rock, alkaline ultramafic rock, metal silicate minerals, metal oxides, carbonates, mycelium, salts, compressed gas, or combinations thereof.

13. The method of claim 11, wherein the substrate includes the naturally occurring material disposed between at least two sheets of a base material.

14. The method of claim 11, wherein the substrate includes the naturally occurring material disposed in a bag.

15. The method of claim 11, wherein an initial buoyancy of the substrate is greater than a threshold buoyancy.

16. The method of claim 15, wherein the substrate has a buoyancy less that the threshold buoyancy after the period of time.

17. The method of claim 16, wherein the threshold buoyancy is based at least in part on a degree of negative buoyancy associated with the threshold amount of biomass accumulation.

18. The method of claim 16, wherein the threshold buoyancy is based at least in part on an uptake of water into the substrate.

19. The method of claim 16, wherein the threshold buoyancy is based at least in part on a loss of a lower-density component from the substrate.

20. The method of claim 19, wherein the lower-density component of the substrate is a gas. 21. A method of using a floating substrate for cultivating a target product, the method comprising:
providing a naturally occurring material;
forming the naturally occurring material into a substrate;
deploying the substrate into a body of water, the substrate being at least one of pre-seeded with a target product before being deployed or configured to attract target product present in the body of water so as to become seeded with the target product after being deployed; and
allowing the substrate to transition from a first configuration to a second configuration when an amount of biomass accumulation of the target product is at least a threshold amount of biomass accumulation.

22. The method of claim 21, wherein a buoyancy of the substrate in the first configuration is greater than a threshold buoyancy and a buoyancy of the substrate in the second configuration is less than the threshold buoyancy.

23. The method of claim 22, wherein the threshold buoyancy is based at least in part on at least one of a degree of negative buoyancy associated with the threshold amount of biomass accumulation, an uptake of water into the substrate, or a loss of a lower-density component from the substrate.

24. The method of claim 23, wherein the lower-density component of the substrate is a gas. 25. The method of claim 23, wherein the threshold buoyancy is a minimum amount of positive buoyancy for flotation, the buoyancy of the substrate in the second configuration allowing the substrate and the target product to sink to a bottom of the body of water.

26. The method of claim 21, wherein the naturally occurring material is at least one of an agricultural waste product or a forest waste product.

27. The method of claim 21, wherein the naturally occurring material is at least one of grasses, wood chips, hog fuel, corn cobs, coconut shells, coconut fibers, hemp, jute, compost, xanthum gum, agar, alginate, limestone (CaCO₃), dolomite (MgCa(CO₃)₂), dolostone, magnesite (MgCO₃), lime (CaO), slaked or hydrated lime (Ca(OH)₂), brucite (Mg(OH)₂), magnesium oxide (MgO), pumice, alkaline mafic rock, alkaline ultramafic rock, metal silicate minerals, metal oxides, carbonates, mycelium, salts, compressed gas, or combinations thereof.

28. The method of claim 21, wherein the forming the naturally occurring material into the substrate includes interposing the naturally occurring material between at least two sheets of a base layer.

29. The method of claim 21, wherein the forming the naturally occurring material into the substrate includes disposing the naturally occurring material into a bag formed of a base material.

30. The method of claim 1, wherein the forming the naturally occurring material into the substrate includes disposing the naturally occurring material into a tube formed of a base material.
